(19) United States
(12) Patent Application Publication
(10) Pub. No.: US 2022/0348196 A1
(43) Pub. Date: Nov. 3, 2022

(54) METHOD AND DEVICE FOR OPERATING A FIRST VEHICLE OPERATED IN AN AT LEAST SEMIAUTOMATED MANNER

(71) Applicant: Robert Bosch GmbH, Stuttgart (DE)

(72) Inventor: Johannes Ludwig Foltin, Ditzingen (DE)

(21) Appl. No.: 17/269,210

(22) PCT Filed: Jul. 22, 2019
(86) PCT No.: PCT/EP2019/069717

§ 371 Date: Feb. 17, 2021

(30) Foreign Application Priority Data
Sep. 12, 2018 (DE) 10 2018 215 509.7

(51) Int. Cl. B60W 30/095; B60W 30/18; B60W 50/00

(52) U.S. Cl. CPC B60W 30/0956; B60W 30/18163; B60W 50/0098; B60W 2554/4041; B60W 2754/30; B60W 2552/10; B60W 2710/20; B60W 2710/18

(57) ABSTRACT

A method for operating a first vehicle operated in an at least semiautomated manner. Surrounding-area information and operating data of the first vehicle operated in an at least semiautomated manner are initially acquired. At least one second vehicle traveling ahead in the direction of travel of the first vehicle is detected as a function of the acquired surrounding-area information. At least one collision-free evasive trajectory of the first vehicle is calculated in response to a predicted collision of the second vehicle, as a function of the acquired surrounding-area information and the acquired operating data of the first vehicle. A distance from the first vehicle to the second vehicle is adjusted in such a manner that at least one collision-free evasive trajectory is available. A processing unit and a first vehicle including the processing unit are also described.

### FIELD

The present invention relates to a method for operating a first vehicle operated in an at least semiautomated manner. In addition, the present invention relates to a processing unit that is configured to execute the method of the present invention, as well as to a vehicle including the processing unit of the present invention.

### BACKGROUND INFORMATION

In the automotive branch, adaptive cruise control is available in the context of driver assistance systems. In this connection, for example, a method for automatically adjusting acceleration in the case of a vehicle is described in German Patent Application No. DE 10 2010 006 442 A1.

In an adaptive cruise control unit, the position and the speed of the vehicle traveling ahead is ascertained by a sensor, and the speed and the distance of the succeeding vehicle equipped with this driver assistance system are correspondingly controlled in an adaptive manner, using interventions in the longitudinal drive unit of the vehicle, in particular, by engine and braking actions. If the vehicle traveling ahead carries out full braking, then the following vehicle still comes to a collision-free stop. In this connection, for example, a method for automatically adjusting acceleration in the case of a vehicle is described in German Patent Application No. DE 10 2010 006 442 A1.

An object of the present invention is to provide a method and a device which also allow the following vehicle to come to a collision-free stop in response to a collision of the vehicle traveling ahead. Comparatively speaking, the vehicle traveling ahead comes to a stop considerably more rapidly in a crash than in the case of full brake application of the vehicle traveling ahead.

### SUMMARY

A method according to an example embodiment of the present invention is provided for achieving the object. In addition, a processing unit, as well as a first vehicle operated in an at least semiautomated manner, are provided.

In a method according to an example embodiment of the present invention for operating a first vehicle operated in an at least semiautomated manner, surrounding-area information of the first vehicle operated in an at least semiautomated manner is initially acquired. The surrounding-area information may be, for example, information about the distance from objects in the surroundings and/or information regarding images from the surroundings of the first vehicle. The surrounding-area information may also be data of a digital map, which include, for example, a collision-risk map, traffic density and/or average speed and differences in speed of road users. In addition, operating data of the first vehicle are also acquired. The operating data may include, for example, the current speed and/or the current steering angle of the first vehicle. Depending on the acquired surrounding-area information, at least one second vehicle, which travels in front of the first vehicle, is subsequently detected in the surroundings of the first vehicle. After that, at least one collision-free evasive trajectory of the first vehicle is detected in response to a predicted collision of the second vehicle, as a function of the acquired surrounding-area information and the acquired operating data of the first vehicle. Thus, the collision-free evasive trajectories, which are available to the first vehicle, are checked, in case the second vehicle were to be involved in a collision and would accordingly come to a stop considerably more rapidly than in the case of full brake application. In this case, an accident means anything that would lead to a dead stop of the second vehicle more rapidly than in the case of full braking of the second vehicle. Thus, it may be, for example, a collision of the at least one second vehicle traveling ahead with an object, such as a further road user, in the surroundings of the second vehicle traveling ahead. An example of this is a rear-end collision of the second vehicle with further second vehicles traveling ahead. The second vehicle traveling ahead may be the vehicle, which is located directly in front of the first vehicle in the sequence. However, it may also be, for example, a vehicle, which is located further up front in the sequence. In this case, a collision-free evasive trajectory refers to any trajectory of the first vehicle, which allows it to evade the second vehicle in a collision-free manner in response to a crash of the second vehicle. In this case, the surroundings of the first vehicle are taken into account, since, for example, getting out of the way by entering into oncoming traffic may also result in a collision. In a following step, a distance from the first vehicle to the second vehicle is adjusted in such a manner, that at least one collision-free evasive trajectory is available to the first vehicle. Since at least one evasive trajectory is always available to the first vehicle, the safety of the first vehicle is increased considerably.

The at least one evasive trajectory is preferably calculated as a function of an ascertained collision risk of the second vehicle. If, for example, it is determined that the second vehicle is presently swerving and/or not observing the speed limit, then an increased collision risk may be ascertained from this. In addition, e.g., an event, such as a major fire along the route, may distract the driver of the second vehicle and, consequently, lead to an increased risk of collision. In addition, e.g., dropped cargo from a truck may result in an increased collision risk. It is preferably possible for the first vehicle to receive a collision risk, e.g., of other road users, transmitted (car-to-car) via a wireless interface. In the same manner, the first vehicle may be transmitted information in the form of map data about the static accident risk, which may be a function of the course of the road and/or condition of the roadway, and/or about dynamic accident risks, which include the current traffic situation, such as the distance of road users from each other. In particular, the risk of a collision of the second vehicle traveling ahead with further road users is ascertained. If it is determined, for example, that the second vehicle is driving up too closely to a further vehicle traveling ahead, then an increased risk of a rear-end collision may be assumed. Such a situation may be ascertained by the first vehicle, for example, with the aid of at least one radar sensor, which is mounted to the first vehicle in such a manner, that it is allowed to see under and through the second vehicle traveling ahead.

Such tailgating of the second vehicle may be detected, for example, via a car-to-car and/or car-to-infrastructure communications link. An increased traffic density, in particular, in response to unadjusted speed of the other road users, may increase the risk of a rear-end collision of the second vehicle with further vehicles traveling ahead. Making the calculation of evasive trajectories a function of the collision risk of the second vehicle has the advantage that the distance may only be adjusted in response to increased collision risk. This vehicle performance produces higher acceptance by the driver of the first vehicle operated in an at least semiautomated manner. The at least one evasive trajectory is preferably calculated as a function of a comparison of the ascertained collision risk to a threshold value. Thus, for example, it may be provided that the at least one collision-free evasive trajectory only be calculated, if the accident risk exceeds the threshold value.

In accordance with an example embodiment of the present invention, a situation preferably occurs, in which the first vehicle is in a first traffic lane of an at least two-lane roadway. In this connection, the at least one evasive trajectory is preferably calculated as a function of a relative position of the first vehicle with respect to at least one further vehicle in at least one second traffic lane of the at least two-lane roadway; the second traffic lane being adjacent to the first traffic lane. By taking into account the traffic in the adjacent traffic lanes during the calculation of the evasive trajectory, it is ensured that other road users are also not put at risk by the collision-free evasive trajectory. The further vehicle in the adjacent second traffic lane may be a moving vehicle or a stationary vehicle. In the case of the two-lane roadway, the first or the adjacent, second traffic lane may be a hard shoulder. In connection with a moving vehicle as a further vehicle, the distance from the first vehicle to the second vehicle is preferably adjusted in such a manner, that the first vehicle is allowed to make a lane change to a second traffic lane adjacent to a first traffic lane of the first vehicle, as an available evasive trajectory. The first vehicle positions itself appropriately in the traffic in such a manner, that a lane change into a free space in an adjacent traffic lane is always rendered possible. Consequently, the first vehicle is allowed a manner of springing into a hole in response to an actual collision of the second vehicle.

The distance from the first vehicle to the second vehicle is preferably adjusted in such a manner, that at least two free, collision-free evasive trajectories are available. If a calculated evasive trajectory is actually unexpectedly no longer available, the safety of the method is consequently increased, since at least one further evasive trajectory is always available.

Now, if an accident, such as a rear-end collision, of the second vehicle actually occurs, then the first vehicle is preferably steered onto the at least one available evasive trajectory automatically. Automatic steering onto the available evasive trajectory has the advantage of increased safety, since in this case, the reaction is often more rapid than in the case of manual steering. In addition, or as an alternative, the at least one available, evasive trajectory in the event of an actual collision of the second vehicle is indicated to the driver of the vehicle. This increases the acceptance of the method by the driver, since he/she is not overly surprised by an automatic driving maneuver or he/she himself/herself must even carry this out manually. If at least two evasive trajectories are available, the vehicle is preferably steered onto the at least one of the at least two evasive trajectories as a function of an ascertained ride comfort of each of the at least two available, evasive trajectories. Alternatively or additionally, the at least one of the at least two evasive trajectories is preferably indicated to the driver of the vehicle as a function of an ascertained ride comfort of each of the at least two available evasive trajectories. This also increases the acceptance of the method by the driver. If, for example, there is the choice between driving onto a field and onto a hard shoulder, then the hard shoulder corresponds to a considerably higher level of ride comfort than the field and would also be preferred by the driver.

The at least one available evasive trajectory preferably corresponds to braking of the first vehicle, including a change of direction. Consequently, the vehicle avoids the second vehicle and is subsequently brought into a safe state. This increases the safety of the method. In addition, with regard to the route, such braking is considerably shorter in comparison with a possible continuance of travel on the evasive trajectory. Therefore, the calculation of an available evasive trajectory is simplified, since less of a path has to be calculated for the evasive trajectory.

A further example embodiment of the present invention includes a processing unit, which is configured to execute the above-described method for operating a first vehicle operated in an at least semiautomated manner. To this end, the processing unit is configured to receive acquired surrounding-area information and acquired operating data of the first vehicle operated in an at least semiautomated manner. In addition, the processing unit is used for detecting at least one second vehicle traveling ahead in the direction of travel of the first vehicle, as a function of the acquired surrounding-area information. In response to a predicted collision of the second vehicle, the processing unit calculates at least one collision-free evasive trajectory of the first vehicle as a function of the acquired surrounding-area information and the acquired operating data. Furthermore, the processing unit is configured to generate at least one control signal for a longitudinal drive unit of the first vehicle, so that a distance from the first vehicle to the second vehicle is adjusted in such a manner, that at least one collision-free evasive trajectory is available. The processing unit is preferably used for ascertaining a risk of collision of the second vehicle, for example, with other road users, and to calculate the at least one evasive trajectory as a function of the ascertained collision risk.

In addition, the present invention relates to a first vehicle, which is operated in an at least semiautomated manner and includes the processing unit of the present invention, at least one surround sensor for acquiring surrounding-area information of the first vehicle, and at least one further sensor for acquiring operating data of the first vehicle. The at least one surround sensor may be, for example, a radar sensor and/or lidar sensor and/or an ultrasonic sensor and/or a camera unit. The further sensor for acquiring operating data may be, for example, a steering angle sensor and/or a speed sensor. In addition, the first vehicle has a longitudinal drive unit, which includes, for example, an engine unit and/or a brake unit of the first vehicle. In this connection, the longitudinal drive unit is configured to adjust a distance from the first vehicle to the second vehicle, which is traveling ahead and is detected by the processing unit, as a function of the at least one control signal generated by the processing unit; the distance being adjusted in such a manner, that at least one collision-free evasive trajectory is available to the first vehicle.

### BRIEF DESCRIPTION OF THE DRAWINGS

FIG. 1 shows a variant of the processing unit of the present invention schematically, in accordance with an example embodiment.

FIG. 2 shows a variant of the method of the present invention for operating a first vehicle operated in an at least semiautomated manner, in accordance with an example embodiment.

FIG. 3a shows an example of a situation at a first time, at which the first vehicle operated in a semiautomated manner is provided a lane change as an evasive trajectory, in accordance with the present invention.

FIG. 3b shows an example of a situation at a second time, at which the first vehicle operated in a semiautomated manner is provided a lane change as an evasive trajectory, in accordance with the present invention.

FIG. 4 shows an example of a situation, in which a second vehicle traveling ahead actually has an accident, in accordance with the present invention.

FIGS. 5a through 5c show different options for calculating collision-free evasive trajectories, in accordance with the present invention.

### DETAILED DESCRIPTION OF EXAMPLE EMBODIMENTS

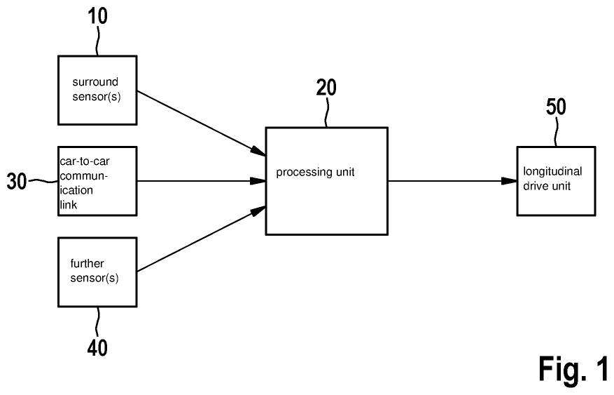

FIG. 1 shows a processing unit 20 schematically, which is configured to receive surrounding-area information of the first vehicle, which is not shown here and is operated in an at least semiautomated manner; the surrounding-area information being received from at least one surround sensor 10. Alternatively, and/or in addition, the surrounding-area information, such as the positions of further vehicles in the surroundings of the vehicle relative to the first vehicle, may be received from processing unit 20 via a car-to-car communications link 30. For example, a collision-risk map may also be received from an external server. In addition, processing unit 20 is used for receiving operating data acquired by at least one further sensor 40 of the first vehicle. Processing unit 20 detects at least one second vehicle traveling ahead in the direction of travel of the first vehicle, as a function of the acquired surrounding-area information. In response to a predicted accident of the second vehicle, processing unit 20 is additionally used for calculating at least one collision-free evasive trajectory of the first vehicle as a function of the acquired surrounding-area information and the acquired operating data of the first vehicle. In addition, processing unit 20 is configured to generate at least one control signal for a longitudinal drive unit 50 of the first vehicle, so that a distance from the first vehicle to the second vehicle is adjusted in such a manner, that at least one collision-free evasive trajectory is available.

As an option, processing unit 20 is further configured to ascertain a risk of collision of the second vehicle, in particular, with other road users, and to calculate the at least one evasive trajectory as a function of the ascertained collision risk.

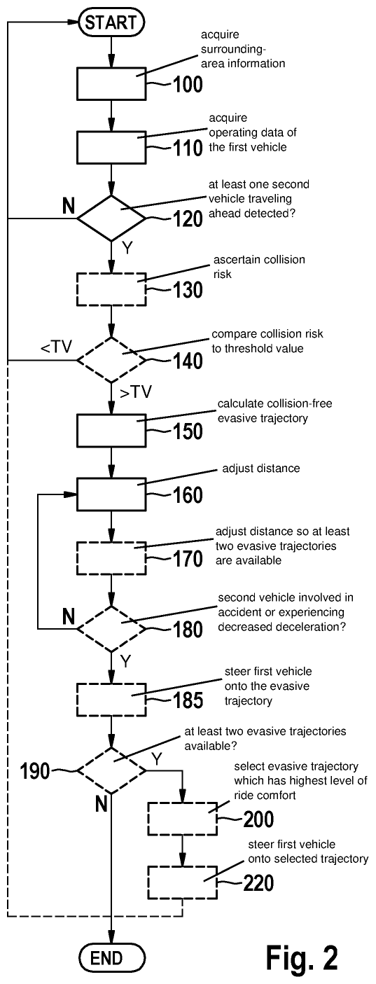

FIG. 2 shows, in the form of a flow chart, a variant of the method for operating a first vehicle operated in an at least semiautomated manner, in accordance with the present invention. In this connection, in a first method step 100, surrounding-area information of the first vehicle operated in an at least semiautomated manner is initially acquired. In a following method step 110, operating data of the first vehicle are acquired. After that, in method step 120, it is checked if at least one second vehicle traveling ahead in the direction of travel of the first vehicle may be detected as a function of the acquired surrounding-area information. In this case, if it is determined that no second vehicle can be detected, then the method is ended or, as an alternative, started from the beginning. However, if at least one second vehicle is detected in method step 120 then, in a following method step 150, at least one collision-free evasive trajectory of the first vehicle is calculated in response to a predicted collision of the second vehicle. In this connection, the acquired surrounding-area information and the acquired operating data of the first vehicle are taken into account. For example, the current speed may be considered as operating data of the first vehicle. The faster the vehicle currently travels, then, also, the longer the braking distance is as an evasive trajectory of the first vehicle. For example, positions of further vehicles relative to the first vehicle may also be considered as acquired surrounding-area information. For example, if the first vehicle is currently located on an at least two-lane roadway and, in this case, a free space is detected between vehicles in an adjacent lane, then the collision-free evasive trajectory may be a lane change of the first vehicle. For example, an instance of braking, during which steering is carried out and the first vehicle consequently executes a change of direction, may also be provided as a collision-free evasive trajectory. In a following method step 160, the distance from the first vehicle to the second vehicle is adjusted in such a manner, that at least one collision-free evasive trajectory is available. After that, the method is ended. In connection with the above-described lane change, the distance from the first vehicle to the second vehicle may be adjusted, for example, in such a manner, that the first vehicle is allowed to make a lane change to a second traffic lane adjacent to a first traffic lane of the first vehicle, as an available evasive trajectory.

In an optional method step 130, the current collision risk of the at least one second vehicle is ascertained. In this connection, for example, the operating behavior of the second vehicle may be taken into account. For example, if the second vehicle is currently traveling too fast, then its risk of collision increases. In particular, the risk of collision of the second vehicle with further road users is ascertained. In this case, for example, how close the second vehicle is driving up on further second vehicles, which are located in front of the second vehicle in the direction of travel, may be taken into account. Driving up too closely may increase the risk of a rear-end collision. In the following method step 150, the ascertained collision risk is taken into account in the calculation of the at least one collision-free evasive trajectory.

In a further, optional method step 140, the ascertained collision risk is compared to a threshold value. If the ascertained collision risk is less than the threshold value, then the method is ended or, alternatively, started from the beginning. However, if the ascertained collision risk is greater than the threshold value, then the method is continued at method step 150.

In an optional method step 170 following method step 160, the distance from the first vehicle to the second vehicle is adjusted in such a manner, that at least two evasive trajectories are available.

In a further, optional method step 180, it is checked, as a function of the acquired surrounding-area information of the first vehicle, if the at least one second vehicle is actually involved in an accident and/or is experiencing increased deceleration. In this case, increased deceleration does not mean normal full brake application, but additional braking, which is executed by additional auxiliary devices, such as a brake parachute. In this case, if no collision is detected, then the method continues with method step 160. However, if a collision is detected, then, in method step 185, the first vehicle is steered automatically onto the at least one available evasive trajectory, and/or the at least one available evasive trajectory is indicated to the driver of the first vehicle.

In a further, optional method step 190, it is checked if at least two collision-free evasive trajectories are available. In this case, if no further, available evasive trajectory is ascertained, then the method is ended. However, if at least two evasive trajectories are ascertained, then, in a following method step 200, the evasive trajectory, which has the highest level of ride comfort, is selected. Criteria, which may be considered for this, include, for example, the condition of the ground of the trajectory and/or whether continued travel on the evasive trajectory is permitted. In addition, or as an alternative, the transverse acceleration resulting for the driver of the first vehicle on the evasive trajectory is also taken into account. In this connection, a change of direction at the same value of acceleration is perceived as more uncomfortable than a straight-line evasive trajectory. Alternatively or additionally, the maximum acceleration produced on the evasive trajectory is taken into account. In this case, the evasive trajectory having the lowest maximum acceleration is preferred. In a method step 220 following method step 200, the first vehicle is steered onto the at least one selected evasive trajectory of the at least two evasive trajectories, and/or it is indicated to the driver of the first vehicle.

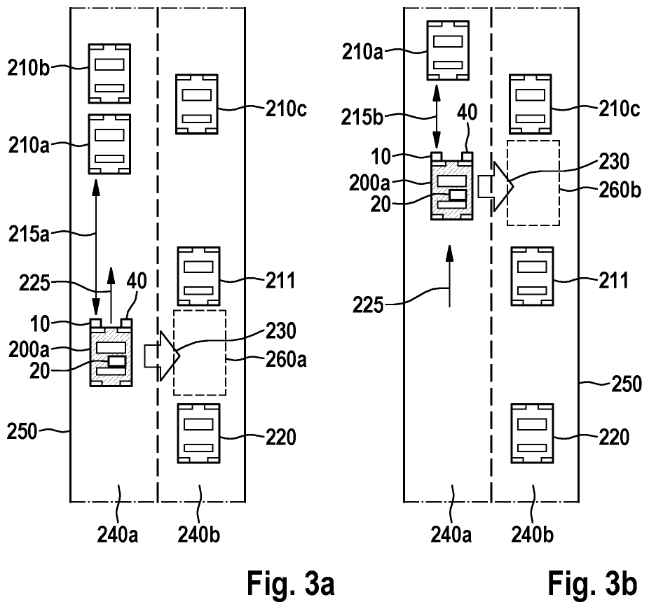

FIG. 3a shows a schematic top view of a two-lane roadway 250 having a first traffic lane 240a and a second traffic lane 240b. A first vehicle 200a operated in an at least semiautomated manner is traveling in first traffic lane 240a in direction of travel 225. In addition to processing unit 20, first vehicle 200a includes a surround sensor 10 and a further sensor 40. Surround sensor 10 is used for acquiring surrounding-area information of first vehicle 200a, and further sensor 40 acquires operating data of first vehicle 200a. Processing unit 20 receives the surrounding-area information and operating data of the first vehicle and detects a plurality of second vehicles 210a, 210b and 210c traveling in front of first vehicle 200a, as a function of the surrounding-area information. Next, processing unit 20 calculates collision-free evasive trajectories in response to a predicted collision of a second vehicle 210a, 210c and 210d. A lane change 230 into a free space 260a in adjacent traffic lane 240b is currently calculated as a possible evasive trajectory 230. Processing unit 20 now generates at least one control signal for the longitudinal drive unit, not shown here, of first vehicle 200a, so that a distance 215a from first vehicle 200a to second vehicle 210a traveling ahead is adjusted in such a manner, that at least one collision-free evasive trajectory 230 is always available. In this situation shown, first vehicle 200a moves in parallel with adjacent vehicles 211 and 220, in order to continually have the option of being able to avoid an actual collision of second vehicle 210a by changing lanes.

FIG. 3b shows the previous situation at a later, second time. Since a free space 260b between vehicles 210c and 211 in adjacent traffic lane 240b was produced up ahead in direction of travel 225, first vehicle 200a has, in the meantime, decreased the distance 215b to the second vehicle 210a traveling ahead. In FIG. 3b, distance 215b between first vehicle 200a and second vehicle 210a is a specific, safe distance, below which the distance may not fall. This safe distance 215b is used so that an adequate braking distance is available to first vehicle 200a in the event of full braking of second vehicle 210.

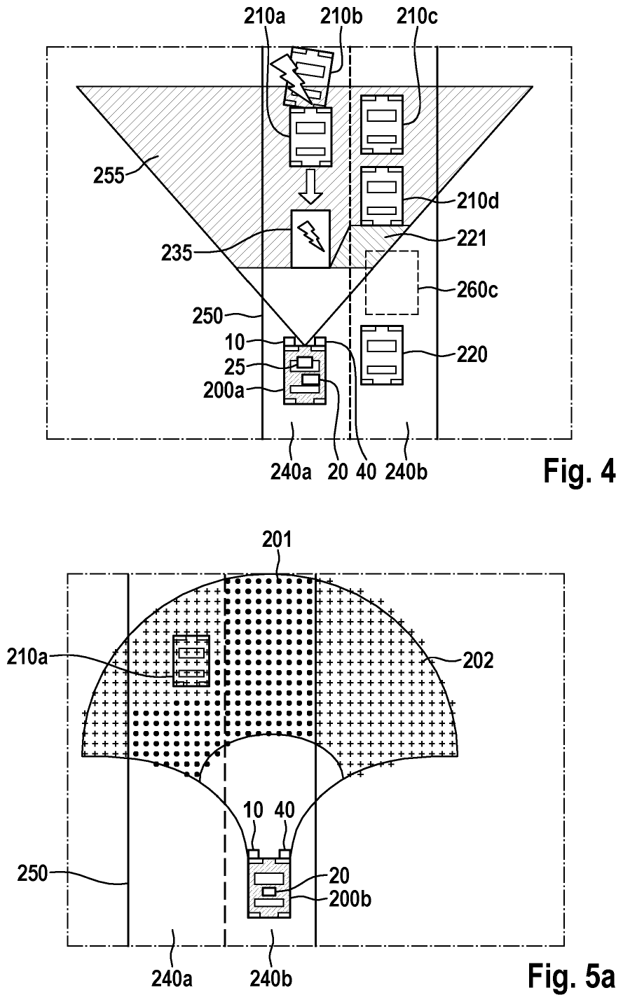

FIG. 4 shows a situation, in which the second vehicle 210a traveling ahead is actually running into a further, second vehicle 210b and, thus, inducing a rear-end collision. As a result, straight-line braking distance 235 for first vehicle 200a is too short, in order to come to a stop in front of second vehicle 210a. In this case, processing unit 20 of first vehicle 200a calculates a lane change into free space 260c between vehicles 210d and 220 as a collision-free evasive trajectory 221. The following lane change is executed automatically, and/or collision-free evasive trajectory 221 is indicated to the driver of first vehicle 200a on a display unit 25. Hatched region 255 represents the region ascertained by processing unit 20, which, when traveled on, would lead to a collision with the second vehicle or other objects.

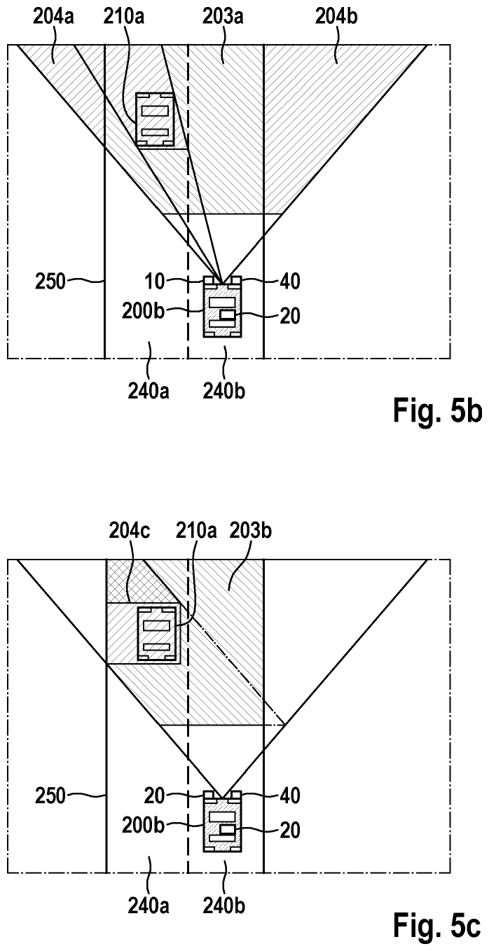

FIG. 5a shows an option for calculating a collision-free evasive trajectory exactly. In this connection, the depicted points 201 denote ascertained end points of calculated, collision-free evasive trajectories, which may be arrived at by steering and/or braking. However, the depicted crosses 202 denote ascertained end points of trajectories, which, when traveled on, would result in collisions with second vehicle 210a or further objects in the surrounding area of first vehicle 200b. The decision as to which end point of a collision-free evasive trajectory would be selected in response to an actual collision of second vehicle 210a, may be made, for example, as a function of the ascertained ride comfort of the respective evasive trajectory.

In comparison with the representation in FIG. 5a, FIGS. 5b and 5c show options for calculating collision-free evasive trajectories, which are less computationally intensive. In this case, not the end points of the collision-free evasive trajectories, but only surfaces 203a and 203b are determined, which may be reached by traveling on a collision-free evasive trajectory. In this connection, in FIG. 5b, only straight lines are used, in order to indicate collision-free surfaces 203a and 203b and non-collision-free surfaces 204a, 204b and 204c. For the sake of simplicity, simple geometric shapes are also used in FIG. 5c, in that the first vehicle is denoted by a rectangle 204c as a non-collision-free surface.

In FIG. 5b, the collision-free regions are calculated in a particularly resource-conserving manner, since a polar coordinate system is used. The surround sensors measure the other road users in polar coordinates, so that the angle and/or visual range 204a surrounding vehicle 210a may be ascertained in a simple manner. In this case, the region, in which second vehicle 210a is located, is assumed to be impassable. Regions outside of the roadway are also indicated as impassable.

A further option for calculating the evasive trajectories is shown in FIG. 5c. In this context, region 204c, in which second vehicle 210a is located, is assumed to be impassable. An advantage of this is that only the lane and the distance of second vehicle 210a have to be known, in order to calculate the possible evasive trajectories. The regions in front of the second vehicle may be handled differently: The region may be assumed to be free or occupied or have a border in the middle. For example, a solid angle may be assumed, e.g., 45°, which first vehicle 240b may reach at the end of the relevant region by steering and braking, and which delimits the range of evasive trajectories from the second vehicle. In this context, it is advantageous that the calculating is particularly simple, since rectangular regions, which run parallelly to the roadway, are often used, which means that resources may be conserved.

In FIGS. 5a through 5c, the regions, into which the first vehicle would fit, if the second vehicle is involved in a rear-end collision and decelerates sharply, may be checked. In this case, because of the simplified calculation of the evasive trajectories, the methods, as shown in FIGS. 5b and 5c, provide a further increase in safety.

1-13. (canceled)

14. A method for operating a first vehicle operated in an at least semiautomated manner, the method comprising the following method steps:
acquiring surrounding-area information of the first vehicle operated in an at least semiautomated manner; and
acquiring operating data of the first vehicle;
detecting at least one second vehicle traveling ahead in a direction of travel of the first vehicle, as a function of the acquired surrounding-area information;
calculating at least one collision-free evasive trajectory of the first vehicle in response to a predicted collision of the second vehicle, as a function of the acquired surrounding-area information and the acquired operating data of the first vehicle; and
adjusting a distance from the first vehicle to the second vehicle in such a manner, that the at least one collision-free evasive trajectory is available for the first vehicle.

15. The method as recited in claim 14, wherein the at least one evasive trajectory is calculated as a function of an ascertained risk of collision of the second vehicle with further road users.

16. The method as recited in claim 15, wherein the at least one evasive trajectory is calculated as a function of a comparison of the ascertained collision risk of the second vehicle with a threshold value.

17. The method as recited in claim 14, wherein the first vehicle is located in a first traffic lane of an at least two-lane roadway, and the at least one evasive trajectory is calculated as a function of an ascertained relative position of the first vehicle with respect to at least one further vehicle in at least one second traffic lane of the at least two-lane roadway.

18. The method as recited in claim 17, wherein the second traffic lane is a hard shoulder.

19. The method as recited in claim 17, wherein the distance from the first vehicle to the second vehicle is adjusted in such a manner that the first vehicle is enabled to make a lane change to a second traffic lane adjacent to a first traffic lane of the first vehicle, as an available, collision-free evasive trajectory.

20. The method as recited in claim 14, wherein the distance from the first vehicle to the second vehicle is adjusted in such a manner that at least two evasive trajectories are available for the first vehicle.

21. The method as recited in claim 14, wherein as a function of an actual collision of the second vehicle, the first vehicle is steered automatically onto the at least one available evasive trajectory, and/or the at least one available evasive trajectory is indicated to the driver of the first vehicle.

22. The method as recited in claim 21, wherein at least two evasive trajectories are available for the first vehicle, and as a function of an ascertained ride comfort of each of the at least two available evasive trajectories, the first vehicle is steered onto the at least one of the at least two evasive trajectories, and/or the at least one of the at least two evasive trajectories is indicated to the driver of the first vehicle.

23. The method as recited in claim 14, wherein the at least one available, collision-free evasive trajectory corresponds to a braking of the first vehicle, including a change of direction.

24. A processing unit configured to operate a first vehicle operated in an at least semiautomated manner, the processing unit configured to:
receive acquired surrounding-area information of the first vehicle operated in an at least semiautomated manner;
receive acquired operating data of the first vehicle; and
detect at least one second vehicle traveling ahead in a direction of travel of the first vehicle, as a function of the acquired surrounding-area information;
calculate at least one collision-free evasive trajectory of the first vehicle, in response to a predicted collision of the second vehicle, as a function of the acquired surrounding-area information and the acquired operating data of the first vehicle; and
generate at least one control signal for a longitudinal drive unit of the first vehicle, so that a distance from the first vehicle to the second vehicle is adjusted in such a manner that the at least one collision-free evasive trajectory is available for the first vehicle.

25. The processing unit as recited in claim 24, wherein the processing unit is configured to ascertain a risk of collision of the second vehicle with other road users, and to calculate the at least one evasive trajectory as a function of the ascertained collision risk.

26. A first vehicle operated in an at least semiautomated manner, comprising:
a processing unit;
at least one surround sensor configured to acquire surrounding-area information of the first vehicle;
at least one further sensor configured to acquire operating data of the first vehicle; and
a longitudinal drive unit;
wherein the processing unit is configured to detect at least one second vehicle traveling ahead in a direction of travel of the first vehicle, as a function of the surrounding-area information acquired by the at least one surround sensor, to calculate at least one collision-free evasive trajectory of the first vehicle in response to a predicted collision of the second vehicle, as a function of the surrounding-area information acquired by the at least one surround sensor and as a function of the operating data of the first vehicle acquired by the at least one further sensor, and to generate at least one control signal for a longitudinal drive unit of the first vehicle so that as a function of the generated control signal, the longitudinal drive unit adjusts a distance from the first vehicle to the second vehicle in such a manner, that the at least one collision-free evasive trajectory is available for the first vehicle.
